(19) United States
(12) Patent Application Publication
(10) Pub. No.: US 2007/0120663 A1
(43) Pub. Date: May 31, 2007

(54) Method and system for wirelessly monitoring equipment in a collision center

(75) Inventor: Robert M. Roewer, West Bloomfield, MI (US)

Correspondence Address: BASF CORPORATION;Patent Department, 1609 BIDDLE AVENUE, MAIN BUILDING, WYANDOTTE, MI, 48192, US

(73) Assignee: BASF Corporation, Southfield, MI (US)

(21) Appl. No.: 11/290,196

(22) Filed: Nov. 30, 2005

(51) Int. Cl. G08B 1/08; G08B 21/00

(52) U.S. Cl. 340/539.22; 340/680

(57) ABSTRACT

A system for monitoring performance of equipment in a collision center includes a piece of equipment for performing an operation and a sensor for monitoring a performance aspect of the piece of equipment. The sensor produces data relating to the monitored performance aspect. A wireless transmitter is in communication with the sensor for wirelessly transmitting the data produced by the sensor. The system further includes a computer in communication with the wireless transmitter for receiving the data produced by the sensor. A method for monitoring the performance aspect of the piece of equipment in the collision center is also disclosed.

### BACKGROUND OF THE INVENTION

1. Field of the Invention

The invention generally relates to a system and method for monitoring performance of equipment in a collision center.

2. Description of the Related Art

A collision center typically utilizes numerous pieces of equipment in the course of repairing vehicles. This equipment includes, but is not limited to, paint spray booths for painting entire vehicles and/or vehicle components, spray guns, air compressors for producing compressed air used by spray booths, spray guns, and other equipment, pumps, handheld power tools, and fixed power tools.

In the past, these pieces of equipment have been independent, autonomous devices that are physically located in and around the collision center. Monitoring and maintenance of this often temperamental equipment has been challenging at best, often requiring collision center personnel to personally inspect equipment numerous times a day. This inspection is necessary in order to ensure the proper function of the equipment and avoid costly repairs and downtime. The manual monitoring, inspection, and maintenance of equipment is both costly and inefficient.

### SUMMARY OF THE INVENTION AND ADVANTAGES

The subject invention provides a system for monitoring performance of equipment in a collision center. The system includes a piece of equipment for performing an operation in the collision center. A sensor monitors a performance aspect of the piece of equipment and produces data relating to the monitored performance aspect. A wireless transmitter is in communication with the sensor for wirelessly transmitting the data produced by the sensor. The system also includes a computer in communication with the wireless transmitter for receiving the data produced by the sensor.

The subject invention also provides a method for monitoring performance of equipment in the collision center. The method includes the step of monitoring the performance aspect of the piece of equipment in the collision center. Data is produced relating to the monitored performance aspect of the piece of equipment. The method also includes the step of wirelessly transmitting the data relating to the monitored performance aspect of the piece of equipment. The data relating to the monitored performance aspect of the piece of equipment is received at the computer.

The system and method of the subject invention provide advantages over the prior art. One advantage is that data relating to the performance of the equipment is available in a single location (i.e., the computer). This allows collision center personnel, including supervisors and managers, to easily anticipate and troubleshoot problems with collision center equipment by notifying the personnel of equipment status faster than personal inspection of the equipment. An additional advantage is that with wireless communications, wiring and rewiring of equipment to facilitate communication between the equipment and the computer is not necessary. Equipment, particularly portable equipment, can be easily moved around the collision center, and still be monitored by the computer and collision center personnel. A further advantage is that real-time data regarding the equipment which is collected by the computer may be used in controlling the equipment by adjusting performance parameters of the equipment.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic view of a system showing a first wireless transmitter integrated with a first sensor and a second wireless transmitter integrated with a second sensor;

FIG. 2 is a schematic view of the system showing a plurality of sensors and a wireless receiver disposed apart from a computer;

FIG. 3 is a schematic view of the system showing a first controller in communication with the first sensor and the first wireless transmitter and a second controller in communication with the second sensor and the second wireless transmitter;

FIG. 4 is a schematic view of the system showing a controller in communication with the first and second sensors and a wireless transmitter;

FIG. 5 is a schematic view of the system showing the computer disposed apart from a collision center;

FIG. 6A is a block diagram of the steps of a method of the subject invention; and

FIG. 6B is block diagram of addition steps of the method of the subject invention.

### DETAILED DESCRIPTION OF THE INVENTION

Referring to the Figures, wherein like numerals indicate corresponding parts throughout the several views, a system 10 and method 100 for monitoring performance of equipment in a collision center 12 are shown.

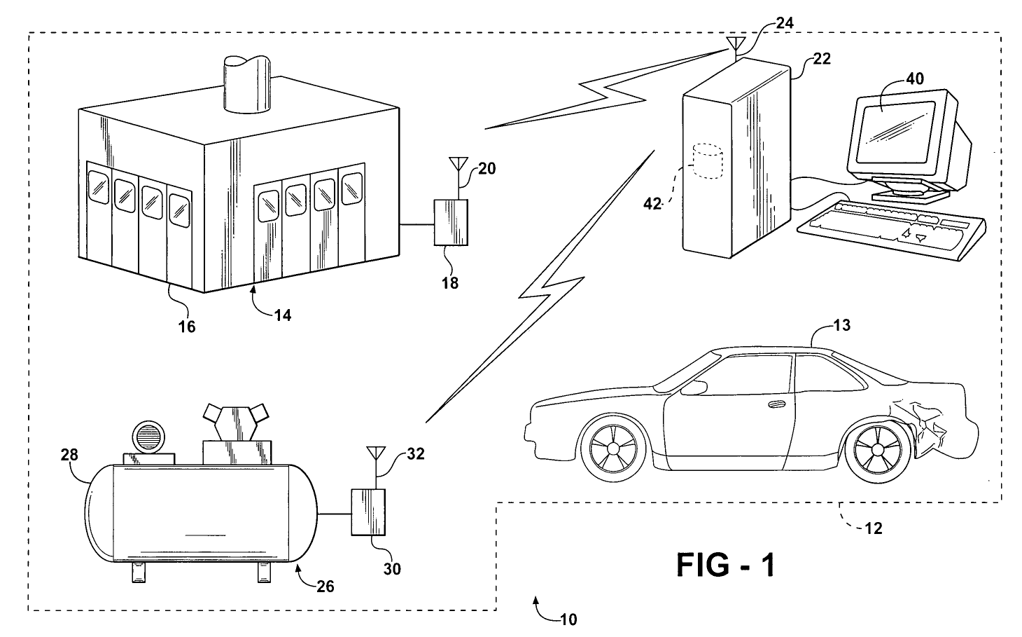

Referring to FIG. 1, the collision center 12 may be an automotive repair facility such as a bump shop, a repair node within an automotive manufacturing plant, or an automotive component supplier. However, those skilled in the art realize that the concepts disclosed herein may be applied to other facilities that utilize equipment in the course of their operations. However, for the purposes of convenience, and to illustrate the preferred embodiments of the invention, the term collision center 12 will be used throughout this disclosure.

The collision center 12 typically utilizes numerous pieces of equipment in the course of repairing vehicles 13. This equipment includes, but is not limited to: paint spray booths and paint spray guns for painting entire vehicles 13 and/or vehicle components; air compressors for producing compressed air used by spray booths, spray guns, and other equipment; paint curing ovens (sometimes incorporated within spray booths); air dryers; framing equipment; welding equipment; pumps; handheld power tools; and fixed power tools.

The system 10 of the present invention includes a piece of equipment 14. This piece of equipment 14 performs an operation for repair of vehicles 13 in the collision center 12 and is preferably located within the confines of the collision center 12. For purposes of illustration, the piece of equipment 14 may be a paint spray booth 16. However, it is to be understood that the first piece of equipment 14 may refer to any of the various types of equipment available in the collision center 12.

A sensor 18 monitors a performance aspect of the piece of equipment 14. Continuing the example of the paint spray booth 16 from above, the performance aspect may include, but is not limited to, a differential pressure across a filter, relative humidity in an air line, baking temperature, an amount of paint in a tank, a rate of air flow, a level of oil, cleanliness of the oil, and a position of a door. The sensor 18 produces data relating to the monitored performance aspect. For example, moisture in paint being applied to the vehicle 13 can result in undesirable results. Consequently, it is critical to measure the relative humidity of compressed air that is used to spray paint onto the vehicle 13. Therefore, the sensor 18 may be a humidistat when measuring relative humidity as the monitored performance aspect.

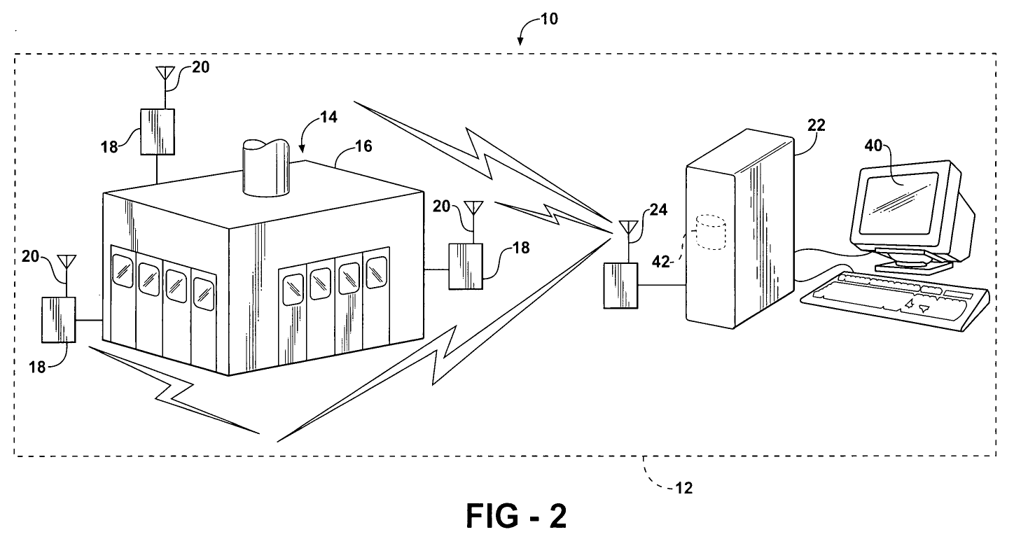

Of course, as shown in FIG. 2, the piece of equipment 14 may include a plurality of sensors 18, with each sensor 18 monitoring a performance aspect of the piece of equipment 14. Each of the plurality first sensors 18 may measure different performance aspects or be used redundantly for backup purposes. Those skilled in the art realize a wide variety of sensor types that may be used, including, but not limited to, pressure sensors, temperature sensors, air flow sensors, position sensors, proximity sensors, and vortex sensors. For ease of description, a single sensor 18 will be used in describing the system 10 from here on, but this description should not be read as limiting in any way.

Referring again to FIG. 1, the system 10 further includes a wireless transmitter 20 in communication with the sensor 18. The wireless transmitter 20 wirelessly transmits the data produced by the sensor 18. Preferably, the wireless transmitter 20 is a radio frequency (RF) transmitter for transmitting the data via an RF signal. Examples of RF wireless transmission of data is known to those skilled in the art and is commonly referred to in various implementations and standards such as WiFi, Bluetooth, PCS, GSM, etc. Alternatively, the wireless transmitter 20 may use infrared light, ultraviolet light, or other wireless techniques to wirelessly transmit the data.

wireless transmitter 20 may be integrated with the sensor 18, such that the wireless transmitter 20 and the sensor 18 are one physical component. Alternatively, the wireless transmitter 20 may be a separate component that is electrically connected to the sensor 18. Those skilled in the art realize that the wireless transmitter 20 may be implemented as a wireless transceiver, i.e., able to transmit and receive wireless signals. Therefore, the sensor 18 is able to wireless receive instructions for configuration, requests for identification, accept instructions, or other features known to those skilled in the art.

The system 10 also includes a computer 22 in communication with the wireless transmitter 20. The computer 22 receives the data produced by the sensor 18. Preferably, the computer 22 includes a wireless receiver 24 that is integrated with the computer 22. As with the wireless transmitter 20, those skilled in the art realize that the wireless receiver 24 may be implemented as a transceiver. Those skilled in the art also realize that the wireless receiver 24 may be a separate component, as shown in FIG. 2. The separate wireless receiver 24 may be, but is not limited to, a wireless network router or a wireless network hub.

The computer 22 is preferably a standard “desktop” PC based around an Intel microprocessor and running the Microsoft Windows operating system 10. Of course, numerous other variations for the computer 22 are well known to those skilled in the art. Those variations include, but are not limited to, a laptop PC, an Apple Macintosh system, an Intel-based PC running Linux, a server-style system, a personal digital assistant (PDA), a cellular phone, a microcontroller, a microprocessor, and an application specific integrated circuit (ASIC).

The use of wireless communication is much preferred as opposed to the use of wired communication (or no communication at all, which is often the case in collision centers 12). Wireless communication requires much less infrastructure investment as no expensive cable runs need to be installed in the collision center 12. Additionally, there is no danger of a cable being cut or damaged, thus resulting in a loss of communication. Furthermore, collision center 12 equipment may be easily moved without having to rewire a wired network.

Because collision centers 12 typically include multiple pieces of equipment, the piece of equipment 14 may also be referred to as a first piece of equipment 14 in order to differentiate one piece of equipment from other equipment. However, this reference should not be read as limiting because those skilled in the art realize that the system 10 only requires a single piece of equipment. Likewise, the sensor 18 may be referred to as a first sensor 18 and the wireless transmitter 20 may be referred to as a first wireless transmitter 20.

Referring again to FIG. 1, the system 10 may also include a second piece of equipment 26 for performing a second operation in the collision center 12. As an example, the second piece of equipment 26 may be an air compressor 28. A second sensor 30 monitors a performance aspect of the second piece of equipment 26 and produces data relating to the monitored performance aspect. Following the air compressor 28 example, the performance aspect monitored by the second sensor 30 may be a pressure measured in a storage tank of the air compressor 28 or the relative humidity of air within or existing the storage tank.

A second wireless transmitter 32 is in communication with the second sensor 30 for wirelessly transmitting the data produced by the second sensor 30. As with the first wireless transmitter 20, the second wireless transmitter 32 is preferably an RF wireless transceiver. The second wireless transmitter 32 may be integrated with the second sensor 30 or a separate component. The computer 22 is also in communication with the second wireless transmitter 32 for receiving the data produced by the second sensor 30.

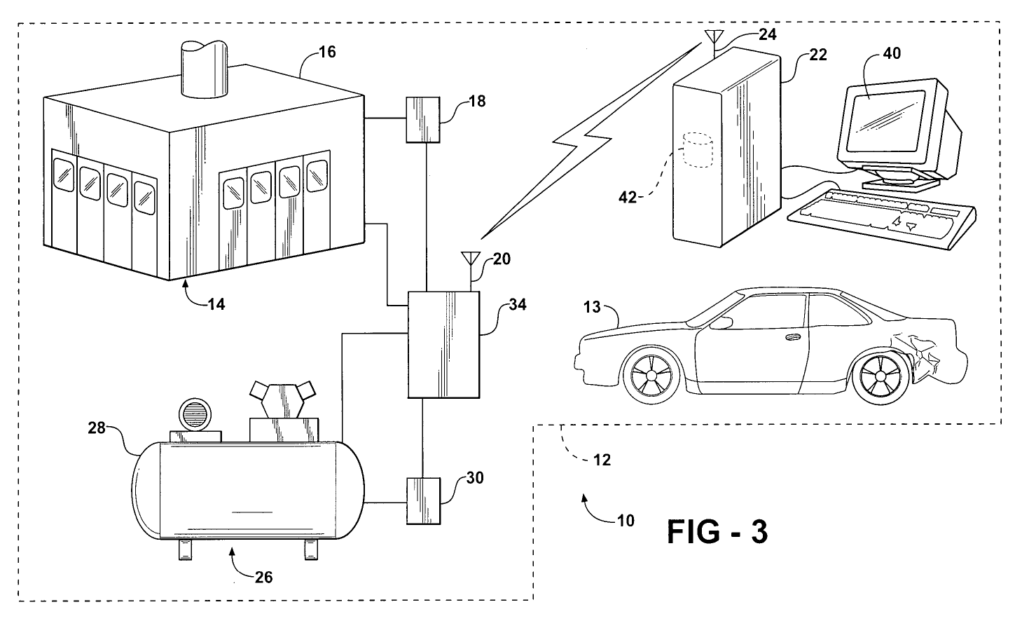

Referring now to FIG. 3, the system 10 may include a controller 34 in communication with the sensor 18 and the wireless transmitter 20. The controller 34 is electrically connected to the piece of equipment 14 and controls the piece of equipment 14. The controller 34 also communicates the data from the sensor 18 to the wireless transmitter 20. The controller 34 may be implemented with a programmable logic controller 38 (PLC), such as those manufactured by Rockwell Automation (Allen-Bradley) or Schneider Electric (Modicon, Square D, Telemecanique), a distributed control system 10 (DCS), a PC, a microcontroller, an ASIC, and/or with other suitable devices known to those skilled in the art.

Where there are multiple pieces of equipment, the controller 34 may be in communication with the first sensor 18, the second sensor 30, the first piece of equipment 14, and the second piece of equipment 26 for controlling the pieces of equipment 14, 26 and communicating the data from the sensors 18, 30 to the first wireless transmitter 20.

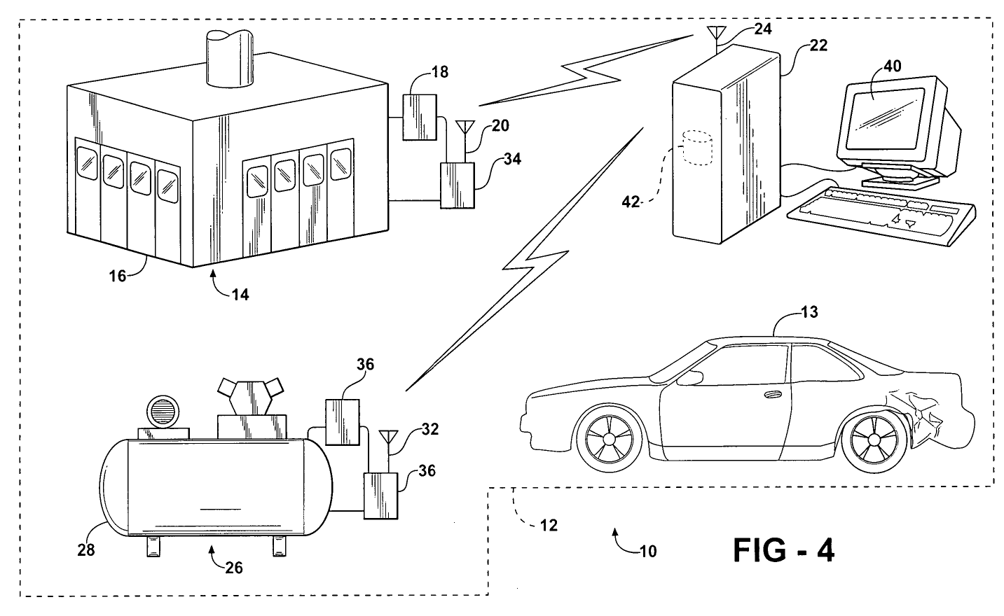

Referring now to FIG. 4, where there are multiple pieces of equipment, the controller 34 may be referred to as a first controller in communication with the first sensor 18 and the first wireless transmitter 20. The first controller 34 controls the first piece of equipment 14 and communicates the data from the first sensor 18 to the first wireless transmitter 20. The system 10 may also include a second controller 36 in communication with the second sensor 30 and the second wireless transmitter 32. The second controller 36 controls the second piece of equipment 26 and communicates the data from the second sensor 30 to the second wireless transmitter 32.

The system 10 preferably includes a display 40 in communication with the computer 22 for displaying the data to a user. The user is typically a collision center 12 supervisor, manager, or maintenance personnel. The data, relating to the pieces of equipment, may be presented on the display in a “dashboard”-type arrangement with other important information concerning collision center 12 operations (e.g., today's work orders, email, inventory levels, etc.). The display 40 may be embodied as a cathrode ray tube (CRT), liquid crystal display (LCD), or plasma screen, such as are commonly used with PCs. Alternatively, the display 40 may also be a light emitting diode (LED) message board, an illuminated light board (“andon” or “bingo” board), or a small LCD screen. Furthermore, the display 40 may be a part of an electronic device separate from the computer 22, such as a cellular phone, pager, or PDA.

The system 10 preferably includes a database 42 in communication with the computer 22. The database 42 stores the data relating to the monitored performance aspect of the first piece of equipment 14 and/or the monitored performance aspect of the second piece of equipment 26 (e.g., the database 42 includes a plurality of records with each record containing the data at a different time interval). The database 42 is preferably integrated with the computer 22, with the data being physically stored on storage devices of the computer 22, such as hard disk drives and random access memory (RAM). However, those skilled in the art realize that the database 42 may be disposed apart from the computer 22. Furthermore, it is preferred that the database 42 include a plurality of databases that are linked to each other. This configuration is well known to those skilled in the art as a “relational database”.

The computer 22, being in communication with the database 42, may perform data analysis operations on the data from the sensors 18, 30. For instance, the computer 22 may compare the data stored in the database 42 to determine a trend in the monitored performance aspects of the first piece of equipment 14 and/or the second piece of equipment 26. For example, the trend of the differential pressure across the filter of the paint spray booth 16 may be increasing as the paint spray booth 16 is utilized, showing a gradual clogging of the filter.

The computer 22 may also establish a maintenance schedule for the first piece of equipment 14 and/or the second piece of equipment 26 based on the trend. Following the previous example, the filter of the paint spray booth 16 should be replaced when the differential pressure reaches a predetermined setpoint. To establish the maintenance schedule for the filter, the computer 22 extrapolates the trend to determine a suggest day and/or time to replace the filter or an amount of useful life on the filter. Those skilled in the art realize additional uses for the data stored in the database 42 of the computer 22.

Where at least one of the wireless transmitters 20, 32 and the wireless receiver 24 are transceivers, the system 10 may be used to send commands from the computer 22 to the piece of equipment 14. Therefore, the computer 22 may control the operation of the piece of equipment 14, e.g., to turn the piece of equipment 14 on or off. Furthermore, the computer 22 may also adjust operation of at least one of the pieces of equipment 14, 26 in response to the data relating to the monitored performance aspect of the at least one of the pieces of equipment 14, 26. For example, the computer 22 may have determined a downward trend in air flow in the paint spray booth 16. In response to this downward trend, the computer 22 may send a command to increase a speed of a fan of the paint spray booth 16. This command may be sent to the controller 34 or to a fan motor drive (e.g., a variable frequency drive) that is in communication with the wireless transmitter 20 (transceiver).

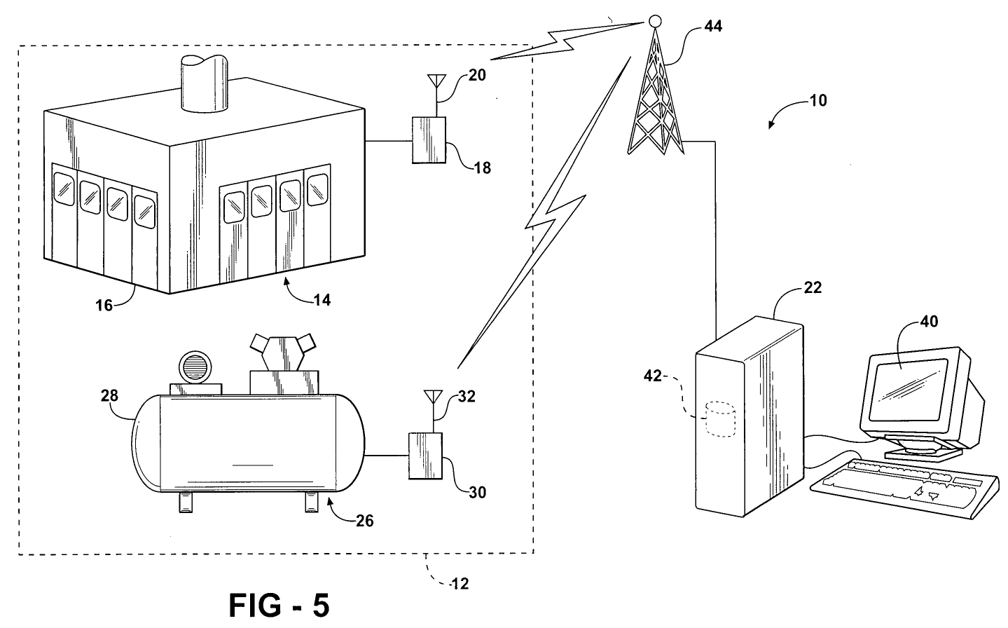

The computer 22 is preferably located within the collision center 12. This allows collision center 12 supervisors, managers, and maintenance personnel who are “on-site” to review and/or manipulate the data. Alternatively, the computer 22 may be located remote from the collision center 12, as shown in FIG. 5. By locating the computer 22 remote from the collision center 12, the computer 22 may be safer from accidental damage that could occur in an often unpredictable collision center 12 environment. Furthermore, the computer 22 maybe located in a headquarters for a collision center chain or a company that provides data collection services for multiple collision centers 12. The first and second wireless transmitters 20, 32 may communicate with the computer 22 wirelessly via a cellular telephone network 44. However, those skilled in the art realize other techniques to wirelessly communicate between the collision center 12 and the remote computer 22, including, but not limited to, a dedicated-frequency microwave link. Additionally, a wireless hub, located within the collision center 12, may receive the data from the wireless transmitters 20, 32, and transmit the data via a wired network, such as the Internet.

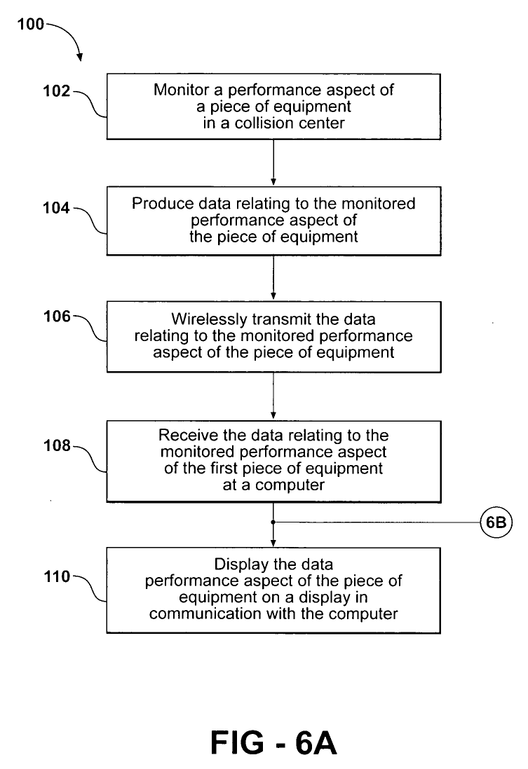

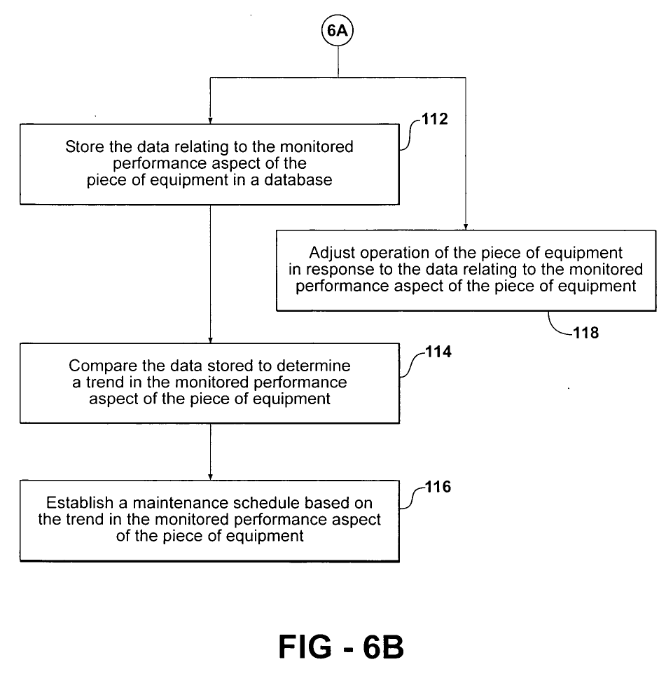

Referring now to FIG. 6A, the method 100 of the subject invention for monitoring performance of equipment in the collision center 12 includes the step of monitoring a performance aspect of the piece of equipment 14 in the collision center 12. The method 100 continues with the step of producing data relating to the monitored performance aspect of the piece of equipment 14. The method 100 also includes the step of wirelessly transmitting the data relating to the monitored performance aspect of the piece of equipment 14. The data is received at the computer 22. The method 100 further includes the step of displaying the data relating to the monitored performance aspect of the piece of equipment 14 on a display 40 in communication with the computer 22.

Referring now to FIG. 6B, the method 100 may also include the additional steps of storing 112 the data relating to the monitored performance aspect of the piece of equipment 14 in the database 42, comparing 114 the data stored to determine a trend in the monitored performance aspect of the piece of equipment 14, and establishing 116 a maintenance schedule based on the trend in the monitored performance aspect of the piece of equipment 14. The method 100 may also include the step of adjusting 118 operation of the piece of equipment in response to the data relating to the monitored performance aspect of the piece of equipment.

Obviously, many modifications and variations of the present invention are possible in light of the above teachings. The invention may be practiced otherwise than as specifically described within the scope of the appended claims.

What is claimed is:

1. A system for monitoring performance of equipment in a collision center, said system comprising:
a piece of equipment for performing an operation in the collision center;
a sensor for monitoring a performance aspect of said piece of equipment and producing data relating to the performance aspect;
a wireless transmitter in communication with said sensor for wirelessly transmitting the data produced by said sensor; and
a computer in communication with said wireless transmitter for receiving the data produced by said sensor.

2. A system as set forth in claim 1 wherein said wireless transmitter is integrated with said sensor.

3. A system as set forth in claim 1 further comprising a controller in communication with said sensor and said wireless transmitter for controlling said piece of equipment and communicating the data from said sensor to said wireless transmitter.

4. A system as set forth in claim 1 wherein said sensor for monitoring a performance aspect of said piece of equipment is further defined as a plurality of sensors for monitoring a plurality of performance aspects of said piece of equipment.

5. A system as set forth in claim 1 wherein said piece of equipment is further defined as a first piece of equipment for performing a first operation in the collision center, said sensor is further defined as a first sensor for monitoring a first performance aspect of said first piece of equipment and producing data relating to the first performance aspect, and further comprising a second piece of equipment for performing a second operation in the collision center.

6. A system as set forth in claim 5 further comprising a second sensor for monitoring a second performance aspect of said second piece of equipment and producing data relating to the second performance aspect.

7. A system as set forth in claim 6 wherein said wireless transmitter is further defined as a first wireless transmitter in communication with said first sensor for wirelessly transmitting the data produced by said first sensor and further comprising a second wireless transmitter in communication with said second sensor for wirelessly transmitting the data produced by said second sensor.

8. A system as set forth in claim 7 wherein said second wireless transmitter is integrated with said second sensor.

9. A system as set forth in claim 7 wherein said computer is in communication with said first wireless transmitter for receiving the data produced by said first sensor and said second wireless transmitter for receiving the data produced by said second sensor.

10. A system as set forth in claim 7 further comprising a first controller in communication with said first sensor and said first wireless transmitter for controlling said first piece of equipment and communicating the data from said first sensor to said first wireless transmitter.

11. A system as set forth in claim 8 further comprising a second controller in communication with said second sensor and said second wireless transmitter for controlling said second piece of equipment and communicating the data from said second sensor to said second wireless transmitter.

12. A system as set forth in claim 6 further comprising a controller in communication with said first and second sensors and said first and second wireless transmitters for controlling said first and second pieces of equipment and communicating the data from said first and second sensors to said wireless transmitter.

13. A system as set forth in claim 1 further comprising a display in communication with said computer for displaying the data to a user.

14. A system as set forth in claim 1 wherein said wireless transmitter is further defined as a radio frequency (RF) transmitter for transmitting the data via an RF signal.

15. A system as set forth in claim 1 wherein said piece of equipment is further defined as a paint spray booth.

16. A system as set forth in claim 15 wherein said sensor is further defined as a humidistat for measuring relative humidity of compressed air used by said paint spray booth.

17. A system as set forth in claim 15 wherein said sensor is further defined as a temperature sensor for measuring a baking temperature within said paint spray booth.

18. A system as set forth in claim 1 wherein said piece of equipment is further defined as an air compressor.

19. A system as set forth in claim 1 further comprising a database in communication with said computer for storing the data relating to the monitored performance aspect of said piece of equipment.

20. A system as set forth in claim 19 wherein said computer compares the data stored in said database to determine a trend in the monitored performance aspect of the first piece of equipment and establishes a maintenance schedule for said first piece of equipment based on the trend.

21. A system as set forth in claim 1 wherein said computer is located within the collision center.

22. A system as set forth in claim 1 wherein said computer is located remote from the collision center.

23. A method for monitoring performance of equipment in a collision center, said method comprising the steps of:
monitoring a performance aspect of a piece of equipment in the collision center;
producing data relating to the monitored performance aspect of the piece of equipment;
wirelessly transmitting the data relating to the monitored performance aspect of the piece of equipment; and
receiving the data relating to the monitored performance aspect of the piece of equipment at a computer.

24. A method as set forth in claim 23 further comprising the step of displaying the data relating to the monitored performance aspect of the piece of equipment on a display in communication with the computer.

25. A method as set forth in claim 23 further comprising the step of storing the data relating to the monitored performance aspect of the piece of equipment in a database.

26. A method as set forth in claim 25 further comprising the step of comparing the data stored to determine a trend in the monitored performance aspect of the piece of equipment.

27. A method as set forth in claim 26 further comprising the step of establishing a maintenance schedule based on the trend in the monitored performance aspect of the piece of equipment.

28. A method as set forth in claim 23 further comprising the step of adjusting operation of the piece of equipment in response to the data relating to the monitored performance aspect of the piece of equipment.
